(19) United States
(12) Patent Application Publication
(10) Pub. No.: US 2018/0191779 A1
(43) Pub. Date: Jul. 5, 2018

(54) Flexible Deception Architecture

(71) Applicant: vArmour Networks, Inc., Mountain View, CA (US)

(72) Inventors: Choung-Yaw Shieh, Palo Alto, CA (US); Zhiping Liu, Saratoga, CA (US); Yi Hung Cheng, Taipei (TW); Chien Yang Hsu, New Taipei City (TW); Hsin Tien Tseng, Taipei (TW)

(21) Appl. No.: 15/394,640

(22) Filed: Dec. 29, 2016

(51) Int. Cl. H04L 29/06

(52) U.S. Cl. CPC H04L 63/1491; G06F 17/30117; H04L 63/101; H04L 63/1425

(57) ABSTRACT

Methods and systems for are provided. Exemplary methods include: getting an image for the application; creating an instance of the application in a container using the image; receiving a network communication, the network communication including an instruction for the application; processing the instruction using the instance; responding to the network communication using the processing; and monitoring behavior from the processing, the monitoring including intercepting library calls, function calls, messages, and events from the container.

### FIELD OF THE INVENTION

The present technology pertains to computer security, and more specifically to computer network security.

### BACKGROUND ART

A hardware firewall is a network security system that controls incoming and outgoing network traffic. A hardware firewall generally creates a barrier between an internal network (assumed to be trusted and secure) and another network (e.g., the Internet) that is assumed not to be trusted and secure.

Attackers breach internal networks to steal critical data. For example, attackers target low-profile assets to enter the internal network. Inside the internal network and behind the hardware firewall, attackers move laterally across the internal network, exploiting East-West traffic flows, to critical enterprise assets. Once there, attackers siphon off valuable company and customer data.

### SUMMARY OF THE INVENTION

Some embodiments of the present technology include computer-implemented methods for imitating an application in a deception point, which may include: getting an image for the application; creating an instance of the application in a container using the image; receiving a network communication, the network communication including an instruction for the application; processing the instruction using the instance; responding to the network communication using the processing; monitoring behavior from the processing, the monitoring including intercepting library calls, function calls, messages, and events from the container; and generating alerts when the behavior is malicious.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments. The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 is a simplified block diagram of a computing environment, according to some embodiments.

FIG. 2 is simplified block diagram of a container environment, according to various embodiments.

FIG. 3 is a higher-level view of the container environment of FIG. 2, in accordance with some embodiments.

FIG. 4 is a simplified block diagram of a deception point environment, according to various embodiments.

FIG. 5 is a simplified block diagram of a deception point environment, in accordance with some embodiments.

FIG. 6 is a simplified flow diagram of a method, according to various embodiments.

FIG. 7 is a simplified block diagram of a test system, according to various embodiments.

FIG. 8 is a simplified flow diagram of a method, in accordance with some embodiments.

FIG. 9 is a simplified block diagram of a computing system, according to various embodiments.

### DETAILED DESCRIPTION

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated. The terminology used herein is for the purpose of describing particular embodiments only and is not intended to be limiting of the technology. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof. It will be understood that like or analogous elements and/or components, referred to herein, may be identified throughout the drawings with like reference characters. It will be further understood that several of the figures are merely schematic representations of the present technology. As such, some of the components may have been distorted from their actual scale for pictorial clarity.

Information technology (IT) organizations face cyber threats and advanced attacks. Firewalls are an important part of network security. Firewalls control incoming and outgoing network traffic using a rule set. A rule, for example, allows a connection to a specific (Internet Protocol (IP)) address (and/or port), allows a connection to a specific (IP) address (and/or port) if the connection is secured (e.g., using Internet Protocol security (IPsec)), blocks a connection to a specific (IP) address (and/or port), redirects a connection from one IP address (and/or port) to another IP address (and/or port), logs communications to and/or from a specific IP address (and/or port), and the like. A firewall rule at a low level of abstraction may indicate a specific (IP) address and protocol to which connections are allowed and/or not allowed.

Managing a set of firewall rules is a difficult challenge. Some IT security organizations have a large staff (e.g., dozens of staff members) dedicated to maintaining firewall policy (e.g., a firewall rule set). A firewall rule set can have tens of thousands or even hundreds of thousands of rules. Some embodiments of the present technology may autonomically generate a reliable declarative security policy at a high level of abstraction. Abstraction is a technique for managing complexity by establishing a level of complexity which suppresses the more complex details below the current level. The high-level declarative policy may be compiled to produce a firewall rule set at a low level of abstraction.

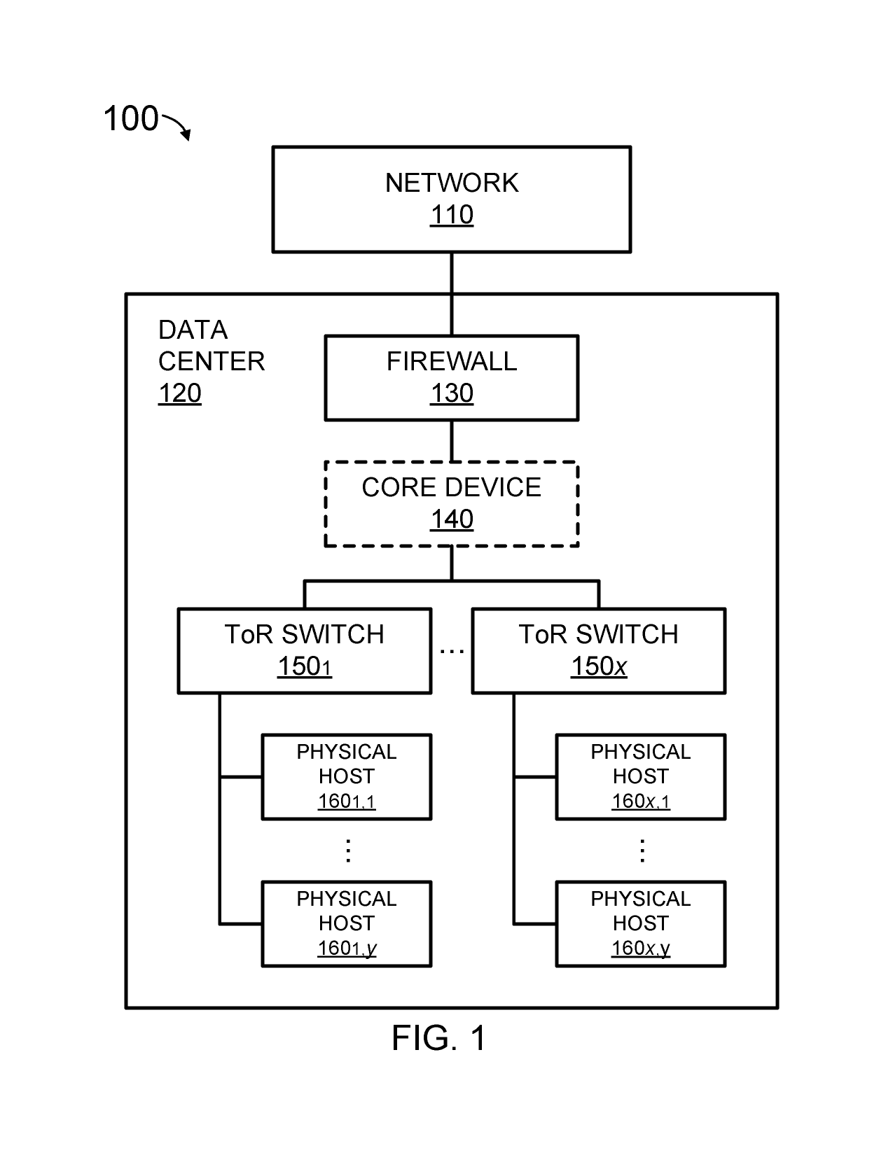

FIG. 1 illustrates a system 100 according to some embodiments. System 100 includes network 110 and data center 120. In various embodiments, data center 120 includes firewall 130, optional core switch/router (also referred to as a core device) 140, Top of Rack (ToR) switches 150₁-150ₓ, and physical hosts 160_{1,1}-160_{x,y}.

Network 110 (also referred to as a computer network or data network) is a telecommunications network that allows computers to exchange data. For example, in network 110, networked computing devices pass data to each other along data connections (e.g., network links). Data can be transferred in the form of packets. The connections between nodes may be established using either cable media or wireless media. For example, network 110 includes at least one of a local area network (LAN), wireless local area network (WLAN), wide area network (WAN), metropolitan area network (MAN), and the like. In some embodiments, network 110 includes the Internet.

Data center 120 is a facility used to house computer systems and associated components. Data center 120, for example, comprises computing resources for cloud computing services or operated for the benefit of a particular organization. Data center equipment, for example, is generally mounted in rack cabinets, which are usually placed in single rows forming corridors (e.g., aisles) between them. Firewall 130 creates a barrier between data center 120 and network 110 by controlling incoming and outgoing network traffic based on a rule set.

Optional core switch/router 140 is a high-capacity switch/router that serves as a gateway to network 110 and provides communications between ToR switches 150₁ and 150ₓ, and between ToR switches 150₁ and 150ₓ and network 110. ToR switches 150₁ and 150ₓ connect physical hosts 160_{1,1}-160_{1,y} and 160_{x,1}-160_{x,y} (respectively) together and to network 110 (optionally through core switch/router 140). For example, ToR switches 150₁-150ₓ use a form of packet switching to forward data to a destination physical host (of physical hosts 160_{1,1}-160_{x,y}) and (only) transmit a received message to the physical host for which the message was intended.

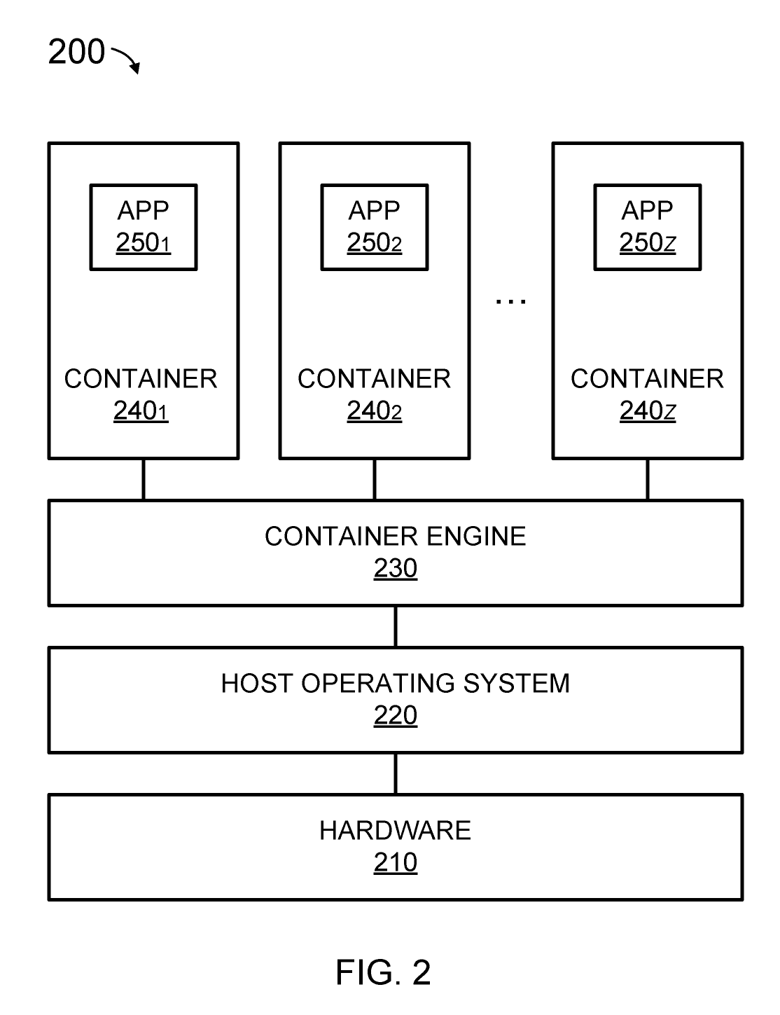

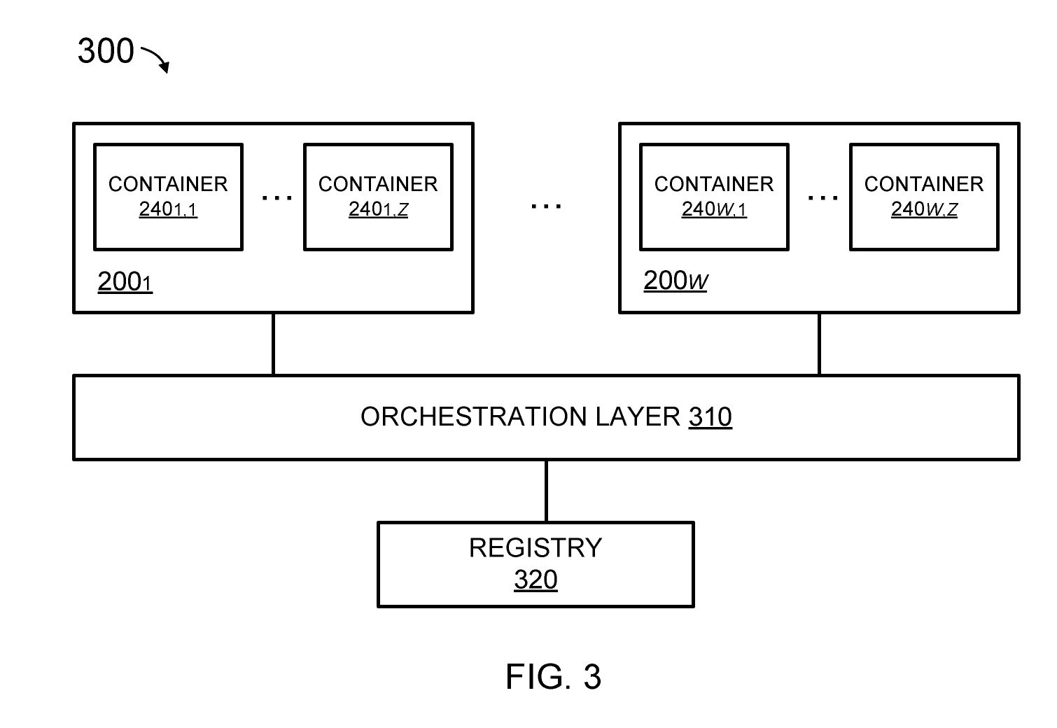

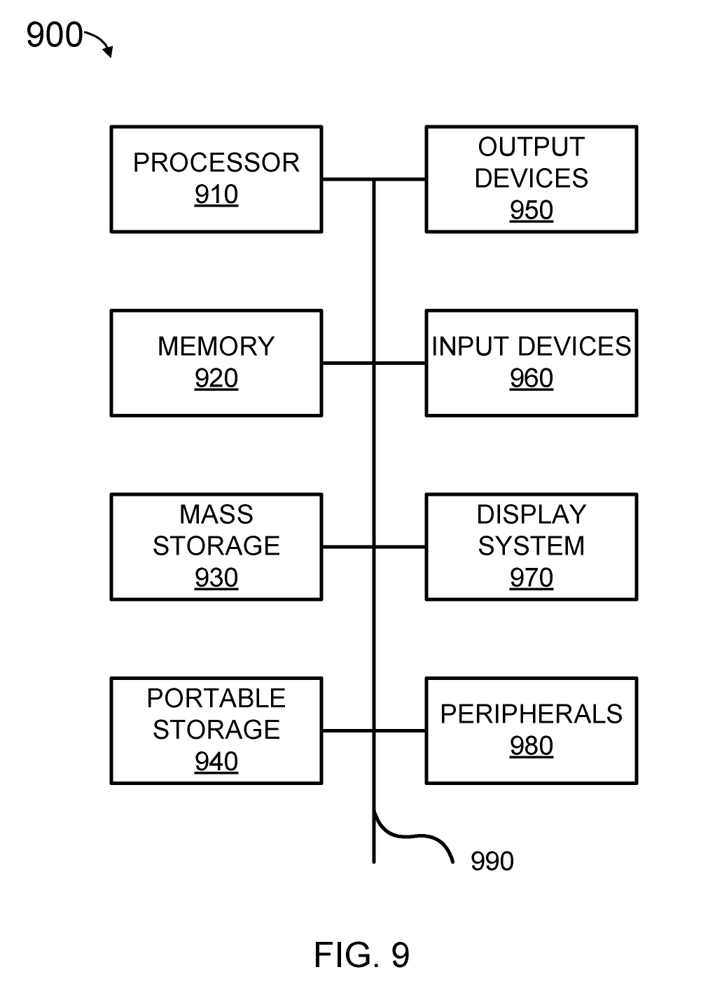

In some embodiments, physical hosts 160_{1,1}-160_{x,y} are computing devices that act as computing servers such as blade servers. Computing devices are described further in relation to FIG. 9. For example, physical hosts 160_{1,1}-160_{x,y} comprise physical servers performing the operations described herein, which can be referred to as a bare-metal server environment. Additionally or alternatively, physical hosts 160_{1,1}-160_{x,y} may be a part of a cloud computing environment. Cloud computing environments are described further in relation to FIG. 9. By way of further non-limiting example, physical hosts 160_{1,1}-160_{x,y} can host different combinations and permutations of virtual and container environments (which can be referred to as a virtualization environment), which are described further below in relation to FIGS. 2-3.

FIG. 2 depicts (container) environment 200 according to various embodiments. Environment 200 includes hardware 210, host operating system 220, container engine 230, and containers 240₁-240_{z}. In some embodiments, hardware 310 is implemented in at least one of physical hosts 160_{1,1}-160_{x,y} (FIG. 1). Host operating system 220 runs on hardware 210 and can also be referred to as the host kernel. By way of non-limiting example, host operating system 220 can be at least one of: Linux, Red Hat® Enterprise Linux® Atomic Enterprise Platform, CoreOS®, Ubuntu® Snappy, Pivotal Cloud Foundry®, Oracle® Solaris, and the like. Host operating system 220 allows for multiple (instead of just one) isolated user-space instances (e.g., containers 240₁-240_{z}) to run in host operating system 220 (e.g., a single operating system instance).

Host operating system 220 can include a container engine 230. Container engine 230 can create and manage containers 240₁-240_{z}, for example, using an (high-level) application programming interface (API). By way of non-limiting example, container engine 230 is at least one of Docker®, Rocket (rkt), Solaris Containers, and the like. For example, container engine 230 may create a container (e.g., one of containers 240₁-240_{z}) using an image. An image can be a (read-only) template comprising multiple layers and can be built from a base image (e.g., for host operating system 220) using instructions (e.g., run a command, add a file or directory, create an environment variable, indicate what process (e.g., application or service) to run, etc.). Each image may be identified or referred to by an image type. In some embodiments, images (e.g., different image types) are stored and delivered by a system (e.g., server side application) referred to as a registry or hub (not shown in FIG. 2).

Container engine 230 can allocate a filesystem of host operating system 220 to the container and add a read-write layer to the image. Container engine 230 can create a network interface that allows the container to communicate with hardware 210 (e.g., talk to a local host). Container engine 230 can set up an Internet Protocol (IP) address for the container (e.g., find and attach an available IP address from a pool). Container engine 230 can launch a process (e.g., application or service) specified by the image (e.g., run an application, such as one of APP 250₁-250_{z}, described further below). Container engine 230 can capture and provide application output for the container (e.g., connect and log standard input, outputs and errors). The above examples are only for illustrative purposes and are not intended to be limiting.

Containers 240₁-240_{z} can be created by container engine 230. In some embodiments, containers 240₁-240_{z} are each an environment as close as possible to an installation of host operating system 220, but without the need for a separate kernel. For example, containers 240₁-240_{z} share the same operating system kernel with each other and with host operating system 220. Each container of containers 240₁-240_{Z} can run as an isolated process in user space on host operating system 220. Shared parts of host operating system 220 can be read only, while each container of containers 240₁-240_{z} can have its own mount for writing. Each of containers 240₁-240_{z} can be referred to as workloads and/or endpoints. Workloads can generally be various combinations and permutations of virtual machines, containers (e.g., containers 240₁-240_{z} shown in FIG. 2), bare-metal servers (e.g., physical host 160_{1,1}-160_{x,y} shown in FIG. 1), and the like running an application or service.

Containers 240₁-240_{z} can include one or more applications or services (APP) 250₁-250_{z} (and all of their respective dependencies). APP 250₁-250_{z} can be any application or service. By way of non-limiting example, APP 250₁-250_{z} can be a database (e.g., Microsoft® SQL Server®, MongoDB, HTFS, MySQL®, Oracle® database, etc.), email server (e.g., Sendmail®, Postfix, qmail, Microsoft® Exchange Server, etc.), message queue (e.g., Apache® Qpid™, RabbitMQ®, etc.), web server (e.g., Apache® HTTP Server™, Microsoft® Internet Information Services (IIS), Nginx, etc.), Session Initiation Protocol (SIP) server (e.g., Kamailio® SIP Server, Avaya® Aura® Application Server 5300, etc.), other media server (e.g., video and/or audio streaming, live broadcast, etc.), file server (e.g., Linux server, Microsoft® Windows Server®, Network File System (NFS), HTTP File Server (HFS), Apache® Hadoop®, etc.), service-oriented architecture (SOA) and/or microservices process, object-based storage (e.g., Lustre®, EMC® Centera®, Scality® RING®, etc.), directory service (e.g., Microsoft® Active Directory®, Domain Name System (DNS) hosting service, etc.), monitoring service (e.g., Zabbix®, Qualys®, HP® Business Technology Optimization (BTO; formerly OpenView), etc.), logging service (e.g., syslog-ng, Splunk®, etc.), and the like.

In contrast to hypervisor-based virtualization (e.g., virtual machines (VMs); not shown in FIG. 2), containers 240₁-240_{z} may be an abstraction performed at the operating system (OS) level, whereas VMs are an abstraction of physical hardware. Since VMs can virtualize hardware, each VM instantiation can have a full server hardware stack from virtualized Basic Input/Output System (BIOS) to virtualized network adapters, storage, and central processing unit (CPU). The entire hardware stack means that each VM needs its own complete OS instantiation and each VM must boot the full OS.

FIG. 3 illustrates (container) environment 300, according to some embodiments. Environment 300 can include environments 300₁-300_{W} and orchestration layer 310. Environments 200₁-200_{W} can be instances of environment 200 (FIG. 2), include containers 240_{1,1}-240_{W,Z}, and be in at least one of data center 120 (FIG. 1). Containers 240_{1,1}-240_{W,Z}, (e.g., in a respective environment of environments 200₁-200_{W}) can be a container as described in relation to containers 240₁-240_{Z} (FIG. 2).

Orchestration layer 310 can manage and deploy containers 240_{1,1}-240_{W,Z} across one or more environments 200₁-200_{W} in one or more data centers of data center 120 (FIG. 1). In some embodiments, to manage and deploy containers 240_{1,1}-240_{W,Z}, orchestration layer 310 receives one or more image types (e.g., named images) from a data storage and content delivery system referred to as a registry (or hub) 320. By way of non-limiting example, registry 320 can be the Google Container Registry. In various embodiments, orchestration layer 310 determines which environment of environments 200₁-200_{W} should receive each container of containers 240_{1,1}-240_{W,Z} (e.g., based on the environments' 200₁-200_{W} current workload and a given redundancy target). Orchestration layer 310 can provide means of discovery and communication between containers 240_{1,1}-240_{W,Z}. According to some embodiments, orchestration layer 310 runs virtually (e.g., in one or more containers 240_{1,1}-240_{W,Z} orchestrated by a different one of orchestration layer 310 and/or in one or more of a hypervisor (e.g., in a virtualization environment) and/or physically (e.g., in one or more physical hosts of physical hosts 160_{1,1}-160_{x,y} (FIG. 1) in one or more of data center 120). By way of non-limiting example, orchestration layer 310 is at least one of Docker Swarm®, Kubernetes®, Cloud Foundry® Diego, Apache® Mesos™, and the like.

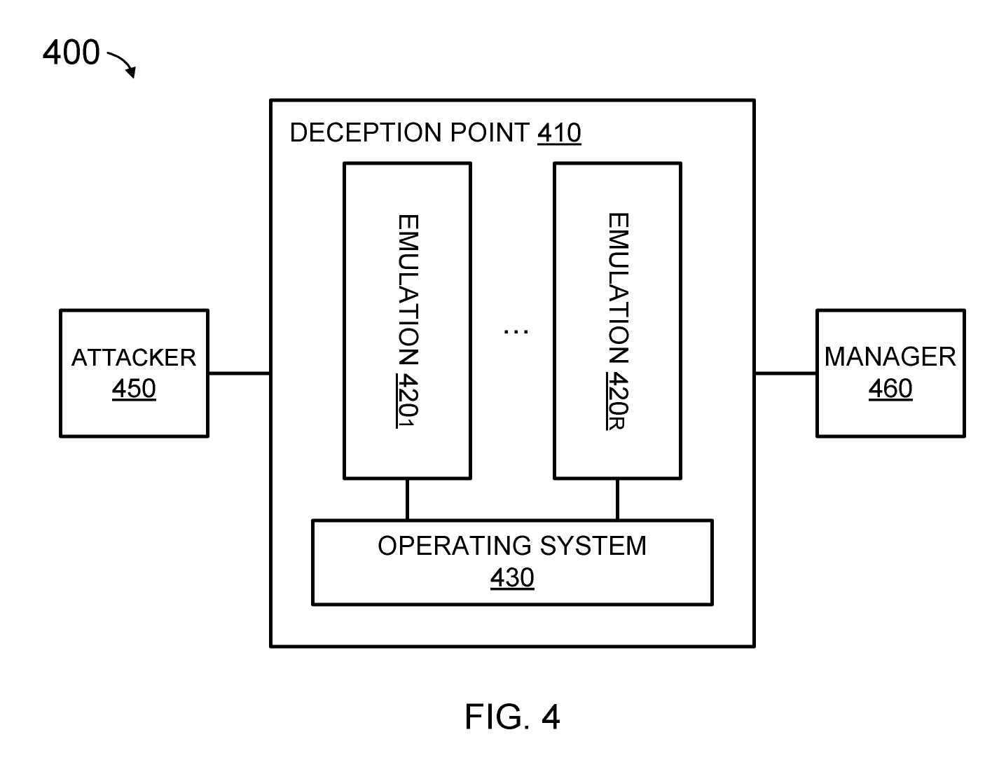

FIG. 4 depicts a simplified block diagram of system 400, in accordance with some embodiments. System 400 may include deception point 410, attacker 450, and manager 460. In some embodiments, deception point 410, and manager 460 are in one or more of data center 120 (FIG. 1).

In some embodiments, deception point 410 comprises host operating system 430 and one or more emulations 420₁-420_{R}. Host operating system 1030 can be an operating system described above in relation to FIG. 2 (e.g., host operating system 220) and/or below in relation to FIG. 9. One or more emulations 420₁-420_{R} can run on host operating system 430. While seeming to provide at least some of the actual service, resources, data, etc. to attacker 450, emulations 420₁-420_{R} are a (isolated) decoy such that actual services, resources, data, etc. are not placed at risk (e.g., not made available to attacker 450). In some embodiments, emulations 420₁-420_{R} communicate with attacker 450 in such a way that the communications appear to originate from an actual workload/server, such as using Network Address Translation (NAT). Deception point 410 provides observation and/or logging of actions taken by attacker 450 accessing emulations 420₁-420_{R}, as if emulations 420₁-420_{R} are an actual workload/server. For example, deception point 410 can monitor and record interactions of emulations 420₁-420_{R} with attacker 450, such as communications between deception point 410 and attacker 450, packet source address, packet source port, packet destination address, packet destination port, protocol, files uploaded and/or downloaded, and the like.

One or more emulations 420₁-420_{R} can be programs (e.g., running as daemons on host operating system 430) that emulate/imitate one or more actual workloads/servers in data center 120 (FIG. 1), such as a name server, time server, authentication server, web server, and the like. Daemons are a type of program that can run unobtrusively in the background (e.g., rather than under the direct control of a user), waiting to be activated by the occurrence of a specific event or condition.

The emulation/imitation can be rudimentary to sophisticated. By way of non-limiting example, (one of) emulations 420₁-420_{R} can provide a simple login window (e.g., username and password prompt) to learn what credential attacker 450 uses. By way of further non-limiting example, (one of) emulations 420₁-420_{R} include a fake hostname and emulate the shell of a Linux server to observe methodologies employed by attacker 450. (One of) Emulations 420₁-420_{R} can allow attacker 450 to load (and install) a file on deception point 410, and the file can subsequently be analyzed for malware. Malware can include a computer virus, worm, Trojan horse, ransomware, spyware, adware, scareware, and other malicious programs.

Each of emulations 420₁-420_{R} can be specifically developed to emulate a particular application and/or service. Moreover, particular implementations and versions of an application and/or service can be emulated. For example, an emulated http server can imitate one (and a version thereof) of: Apache® HTTP Server™, Microsoft® IIS), Nginx, Google Web Server (GWS), and the like. By way of further non-limiting example, an emulated directory service can be a particular one of (and a version thereof): Microsoft® Active Directory®, Domain Name System (DNS) hosting service, and the like. Other applications and services (and versions thereof) can be emulated. Since each of one or more emulations 420₁-420_{R} is custom developed to emulate a particular application and/or service (and a version thereof), the imitation can be rudimentary to sophisticated, depending on the complexity of a particular one of emulations 420₁-420_{R}. However, writing/coding an emulation (e.g., one of emulations 420₁-420_{R}) to support each of the numerous different applications and/or services (and versions thereof) can require an impractically large amount of time, money, and other resources.

In some embodiments, emulations 420₁-420_{R} provide multiple emulations/imitations using one identification (e.g., hostname, IP address, etc.). In various embodiments, emulations 420₁-420_{R} provide certain emulations/imitations using a particular identification (e.g., hostname, IP address, etc.) associated with the one or more emulations/imitations. By way of non-limiting example, a command-line login for SSH and a basic Apache® HTTP Server™ for HTTP can be provided using one identification or separate identifications (e.g., hostname, IP address, etc.).

Manager 460 can manage/configure (one or more of) deception point 410 (e.g., using a management port). For example, adding and/or removing an emulation of emulations 420₁-420_{R} running in deception point 410. Manager 460 can receive a log of incoming and/or outgoing packets (e.g., source address, source port, destination address, destination port, protocol, etc.) and the like from deception point 780A.

Attacker 450 can be a computing system employed by one or more persons (unauthorized user or “hacker”) who seek and exploit weaknesses in data center 120 (FIG. 1). In some embodiments, attacker 450 is a computing system described above in relation to FIG. 9. By way of non-limiting example, attacker 450 attempts to discover information about an intended target computer system and/or computer network, identify potential ways of attack, and compromise the system and/or network by employing the vulnerabilities found through the vulnerability analysis. By way of further non-limiting example, attacker 450 can disrupt the operation of and/or make unauthorized copies of sensitive information in data center 120, through unauthorized access of data center 120. Attacker 450 can be, for example, a computing system outside of data center 120 or a computing system inside data center 120 that was compromised by and under the control an unauthorized user.

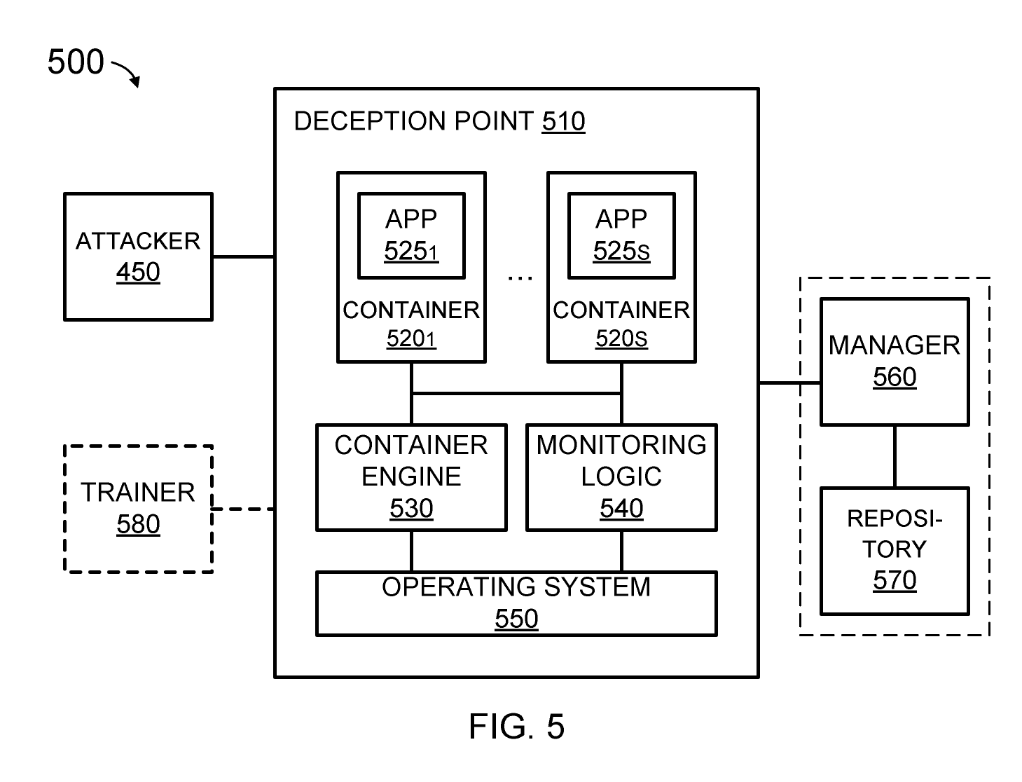

FIG. 5 depicts a simplified block diagram of system 500, in accordance with some embodiments. FIG. 5 illustrates additional and/or alternative elements of system 400 shown in FIG. 4. System 500 may include deception point 510, attacker 450, manager 560, repository 570, and (optional) trainer 580. In some embodiments, at least one of deception point 510, manager 560, repository 570, and (optional) trainer 580 are in one or more of data center 120 (FIG. 1). Applications (APP) 525₁-525_{S} have at least some of the characteristics of applications (APP) 250₁-250_{z} described above in relation to FIG. 2. Manager 560 has at least some of the characteristics of manger 460 described above in relation to FIG. 4. Attacker 450 was described above in relation to FIG. 4.

Deception point 560 has at least some of the characteristics of deception point 460 described above in relation to FIG. 4. Deception point 560 can be combinations and permutations of a computing system as described below in relation to FIG. 9, a bare-metal server (e.g., physical hosts physical hosts 1601,1-160x,y in FIG. 1), and a virtual machine. Additionally and/or alternatively, deception point 560 can monitor and/or log one or more of the following behaviors: inbound and/or outbound network connections; creation of new, changes to, and removal of processes; creation of new, changes to, and removal of files and/or folders; memory usage changes; disk usage changes, network connection bonding of processes (e.g., which processes are listening to which/certain sockets and/or port, which processes initiate network connections, and the like), and the like. As described below, deception point 560 can determine whether certain behaviors are benign or malicious.

In some embodiments, deception point 560 comprises a host operating system 550, container engine 530, monitoring logic 540, one or more containers 520₁-520_{S}, and one or more applications and/or services 525₁-525_{S}. Host operating system 550, container engine 530, one or more containers 520₁-520_{S}, and one or more applications and/or services (APPs) 525₁-525_{S} can have at least some of the characteristics of host operating system 220 (and operating systems as described below in relation to FIG. 9), container engine 230, containers 240₁-240_{z}, and applications (APP) 250₁-250_{z}, respectively, as described above in relation to FIG. 2. In various embodiments, deception point 510 can be run one or more of a bare-metal server (e.g., physical hosts 160_{1,1}-160_{x,y} in FIG. 1) and a virtual machine.

For example, one or more applications and/or services (APP) 525₁-525_{S} can be any of applications and/or services (APP) 250₁-250_{z} (FIG. 2). By way of further non-limiting example, one or more applications and/or services (APP) 525₁-525_{S} can be any of the applications or services emulated by emulations 420₁-420_{R} (FIG. 4). In some embodiments, applications and/or services (APP) 525₁-525_{S} include name servers, time servers, authentication servers, database servers, file servers, and the like. Name servers (e.g., Domain Name System (DNS) server, a server running Active Directory Domain Services (AD DS) called a domain controller, etc.) can implement a network service for providing responses to queries against a directory service. Time servers (e.g., Network Time Protocol (NTP) server) can read an actual time from a reference clock and distribute this information to client computers using a computer network. Authentication servers (e.g., Kerberos server, Terminal Access Controller Access-Control System (TACACS) server, Remote Authentication Dial-In User Service (RADIUS) server) provide a network service that applications use to authenticate the credentials, usually account names and passwords, of their users. Database servers provide database services to other computer programs or computers (e.g., database servers can run Microsoft® SQL Server®, MongoDB, HTFS, MySQL®, Oracle® database, etc.). File servers store, manage, and control access to separate files (e.g., file servers can run Linux server, Microsoft® Windows Server®, Network File System (NFS), HTTP File Server (HFS), Apache® Hadoop®, etc.).

In addition to or instead of emulations 420₁-420_{R} (FIG. 4) written specifically for deception point 410, deception point 510 instantiates a container of an application and/or service to be emulated/imitated. In other words, one or more containers 520₁-520_{S} running one or more applications and/or services 525₁-525_{S} can function as a decoy (e.g., have at least some of the characteristics of emulations 420₁-420_{R}). The same image used to provision the actual (production) application and/or service can also be used by deception point 510 to emulate the application and/or service. Since a corresponding image is used to create containers for the actual (production) application and/or service, images for the actual (production) application and/or service are generally available when the actual (production) application and/or service is released. Thus, images for actual (production) applications and/or services can be readily available for use by deception point 510.

For example, when it is desirable/advantageous to emulate an Apache® HTTP Server™ version 2.4.23 in deception point 510, manager 560 retrieves an image for Apache® HTTP Server™ version 2.4.23 from repository 570. Using the Apache® HTTP Server™ version 2.4.23 image, container engine 530 can create and manage a container (of containers 520₁-520_{S}) (e.g., as described above in relation to FIG. 2) to run the Apache® HTTP Server™ version 2.4.23 instance. In this way, deception point 510 can emulate an Apache® HTTP Server™ version 2.4.23 (using one or more containers 520₁-520_{S} running one or more applications and/or services 525₁-525_{S}). Similarly, deception point 510 can accurately emulate/imitate other applications and/or services—which have been containerized (e.g., set up to run in a container)—using the respective image for each (production) application and/or service.

Deception point 510 can be said to emulate/imitate an application and/or service, insofar as deception point 510 does not use real data. By way of non-limiting example, if the application and/or service is a customer database, then real customer information is not used by deception point 520. By way of further non-limiting example, if the application and/or service is an authentication server, then provided usernames and/or passwords are checked against fake ones (or not really checked) and a fake cryptographic ticket is (automatically) provided. However, deception point 510 can use the same containerized application and/or service image as a real production workload does.

Moreover, an image for each version of a particular (containerized) application and/or service can be available. When new version of an (containerized) application and/or service is released (e.g., for actual use), the corresponding image can be used for emulation/imitation by deception point 510 (using one or more containers 520₁-520_{S} running one or more applications and/or services 525₁-525_{S}).

Hence, custom software does not necessarily have to be written for each emulation (such as in emulations 420₁-420_{R} (FIG. 4)), saving time, money, and other resources. (Using one or more containers 520₁-520_{S} running one or more applications and/or services 525₁-525_{S}) Deception point 520 can offer the advantages of: extended/expanded coverage of applications and/or services which can be emulated/imitated and timely support for new (versions of) applications and/or services which can be emulated/imitated. Containers (e.g., containers 520₁-520_{S}) in deception point 520 can also offer advantages over other virtualization techniques. While deception point 520 can run on a virtual machine, virtual machines should not be substituted for containers (e.g., containers 520₁-520_{S}), because each virtual machine includes its own separate and complete operating system instantiation (in contrast to containers which share host operating system 550 with monitoring logic 540). Hence, virtual machines provide appreciably less visibility into actions taken by attacker 450 than containers 520₁-520_{S}.

Monitoring logic 540 can be an application(s) which monitors operation of (decoy) applications and/or services (APPs) 525₁-525_{S} in response to interactions with attacker 450. In some embodiments, monitoring logic 540 is logically interposed between host operating system 550 and (decoy) applications and/or services (APPs) 525₁-525_{S}. In some embodiments, monitoring logic 540 can include one or more system monitors. For example, monitoring logic 540 hooks (e.g., intercepts) library calls, function calls, messages, events, and the like passed between software components (e.g., in one or more containers 520₁-520_{S}).

By way of further non-limiting example, monitoring logic 540 includes (features and/or functions of) one or more of the following: an application programming interface (API), Linux/etc/ld.so.preload, ptrace (e.g., an abbreviation of “process trace,” can be a system call used to allow one process to control another, enabling the controlling process to inspect and manipulate the internal state of the target process), a daemon which tracks changes to a file, strace (e.g., a program that traces/monitors interactions between processes in one or more containers 520₁-520_{S} and operating system 550, which include system calls, signal deliveries, and changes of process state), struss (e.g., a program that traces system calls), tcpdump (e.g., a packets sniffer or package analyzer tool which is used to capture or filter TCP/IP packets that received transferred over a network on a specific interface(s)), and the like.

By way of further non-limiting example, monitoring logic 540 launches a malware scanner (e.g., internal and/or external to monitoring logic 540) to analyze suspect files which are (e.g., by attacker 450) uploaded (to deception point 510), modified, and the like. For example, monitoring logic can send the suspect file to a malware scanner (e.g., inside and/or outside of data center 100 (FIG. 1). Alternatively or additionally, a hash function can be applied to the suspect file and the resulting hash can be used to retrieve an (prior) analysis of an identical (or similar) file performed internally or by a third-party such as VirusTotal. A hash function (e.g., MD5, SHA1, SHA256, and the like) can be a function which maps data of arbitrary size to data of fixed size, where the values returned by a hash function are referred to as hash values, hash codes, digests, or simply hashes.

In some embodiments, monitoring logic 540 maintains a whitelist of legitimate/authorized actions and/or objects (e.g., DNS query, files of a particular type, URL, hash of an executable file, and the like) such that actions and/or objects not on the whitelist are at least one of: identified as potentially malicious, and further monitored and/or analyzed. An alert can be issued for behaviors not on the whitelist. For example, a (initial) whitelist can be produced using trainer 580. Trainer 580 can connect with deception point 510 to emulate normal/expected user/client interaction with an actual workload (imitated by deception point 510). Deception point 510 can log the behaviors (e.g., changes to files, processes, and network connections) and provide the log to manager 560. Manager 560 can provide the log of behaviors to staff of an information technology (IT) organization (e.g., associated with deception point 510) to identify benign behaviors. Behaviors classified as benign can be stored in the whitelist.

Monitoring logic 540 can additionally or alternatively flag when a container crashes or check for a container crash (e.g., when a container of one or more containers 520₁-520_{S} stops functioning properly) and/or restarts, such as to (subsequently) identify the root cause. By way of additional non-limiting example, monitoring logic 540 detects efforts (e.g., by attacker 450) to crash and/or detect/identify a container of one or more containers 520₁-520_{S}. Monitoring logic 540 can additionally or alternatively detect efforts (e.g., by attacker 450) to crash and/or detect/identify a container of one or more containers 520₁-520_{S}. Monitoring logic 540 can additionally or alternatively scan for patterns (e.g., represented using regular expressions) of an uploaded files (e.g., by attacker 450). By way of further non-limiting example, monitoring logic 540 analyzes (or sends to manger 650 for analysis) service logs produced by a container of one or more containers 520₁-520_{S}.

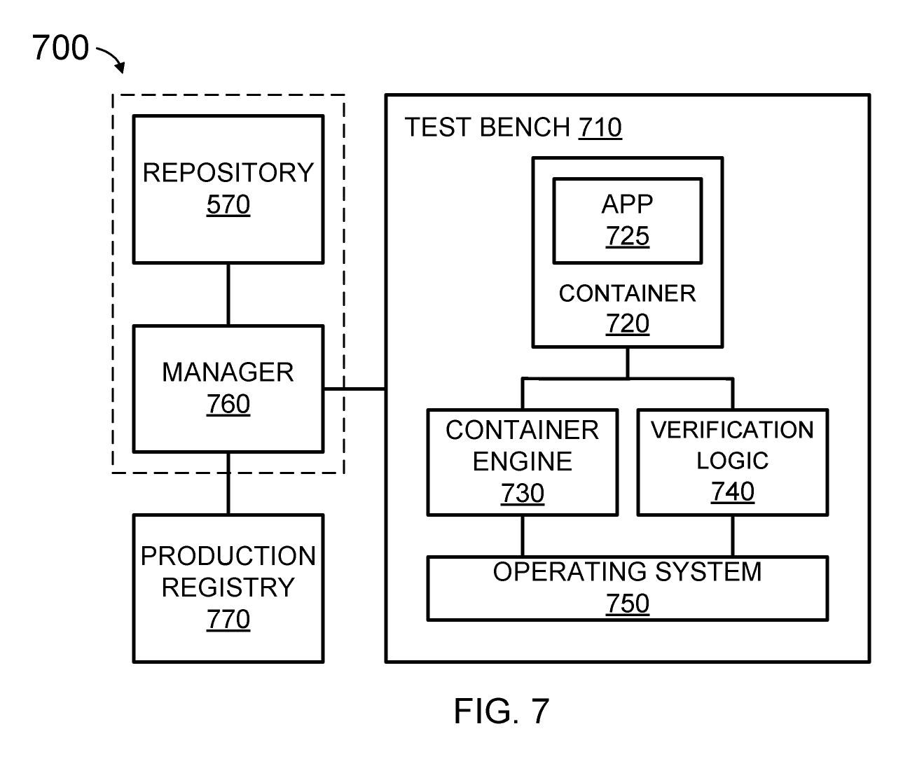

Repository 570 can be a public registry and/or a private registry. Registries and images were described above in relation to FIGS. 2 and 3. For example, a public registry can be a repository of images that are shared publicly, and a private registry can be a repository of images that are to be kept private. By way of further example, a public registry is the Google Container Registry and a private registry is a Docker private registry. According to some embodiments, repository 570 is a data store included in manager 560. In various embodiments, repository 570 can store images that were evaluated for compatibility with deception point 510 in an off-line manner (e.g., prior to instantiating the image(s) in deception point 510). The evaluation is described below in relation to FIG. 7.

In some embodiments, manager 560 can perform at least some of the operations of an orchestration layer (e.g., orchestration layer 410 (FIG. 4). For example, manager 560 can get images associated with an application/service (APP) from repository 570 and communicate with container engine 530 to instantiate the application/service (APP) 525₁-525_{S} in a container of one or more containers 520₁-520_{S}.

In some embodiments, various combinations and permutations of network communications devices (not depicted in FIG. 5)—such as (physical and/or virtual) firewalls, switches, routers, enforcement points, and the like—are (communicatively) interposed between attacker 450 and deception point 510. For example, enforcement points can be a firewall service that provides network traffic filtering and monitoring for virtual machines, containers, bare-metal servers, and the like. Enforcement points are described further in related United States patent application “Methods and Systems for Orchestrating Physical and Virtual Switches to Enforce Security Boundaries” (Application Ser. No. 14/677,827) filed Apr. 2, 2015, which is hereby incorporated by reference for all purposes. According to some embodiments, various combinations and permutations of network communications devices (not depicted in FIG. 5)—such as (physical and/or virtual) firewalls, switches, routers, enforcement points, jump servers (also known as a jump host or jumpbox), and the like—are (communicatively) interposed between deception point 510 and manager 560.

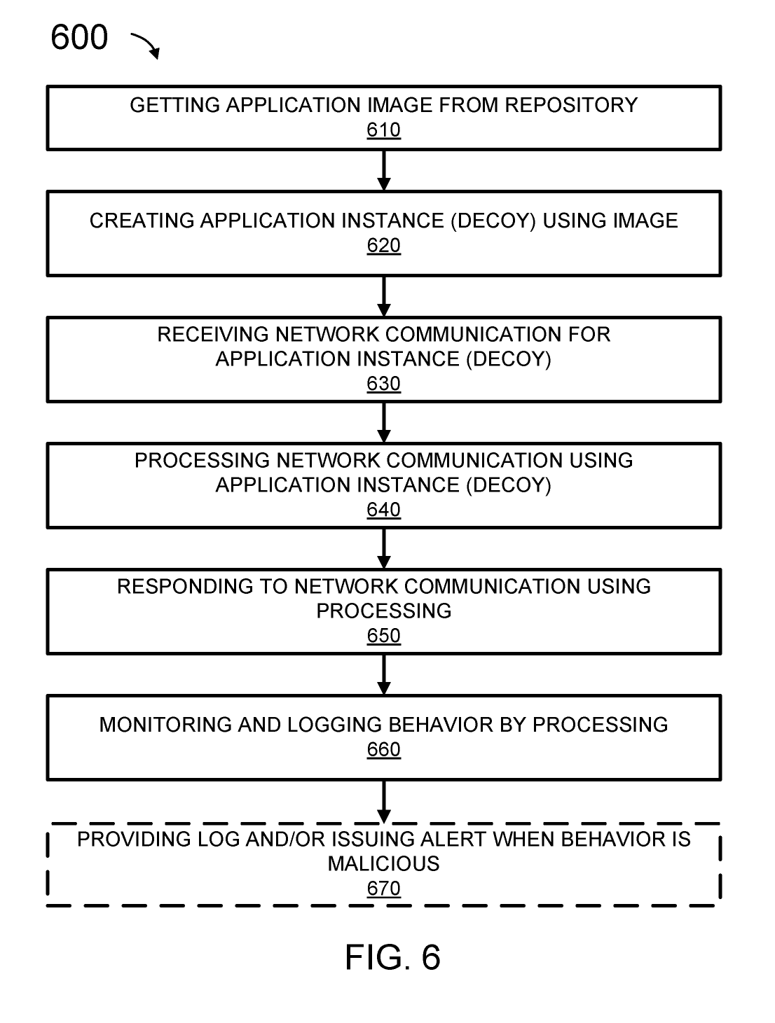

FIG. 6 is a simplified flow diagram for a method 600 for emulating/imitating an application and/or service in a deception point (e.g., deception point 510). In various embodiments, method 600 is performed by deception point 510. At step 610, an image (e.g., basically a snapshot of a container) for an application and/or service is received. In various embodiments, the application image is received from manager 560 (FIG. 5), where manager 560 retrieves the application image from repository 570.

At step 620, a container with the application and/or service is instantiated. In some embodiments, container engine 530 (FIG. 5) creates a container (e.g., one of containers 520₁-520_{S}) for the application and/or service (e.g., one of APP 525₁-525_{S}) using the image. The instantiated container (e.g., one of containers 520₁-520_{S}) for the application and/or service (e.g., one of APP 525₁-525_{S}) can function as a decoy.

At step 630, a network communication is received and directed to the appropriate application and/or service. For example, the network communication is addressed to a particular application and/or service for which there is a decoy (e.g., container running the particular application and/or service) and the communication is provided to the container running the particular application and/or service. In various embodiments, attacker 450 accesses or uses the application and/or service imitated by the application and/or service in the container (functioning as a decoy). For example, the network communication can includes one or more commands, including instructions and data.

At step 640, the network communication is processed using the application instance (operating as a decoy). In some embodiments, an instruction and data in the network communication is processed by one of application and/or service APP 525₁-525_{S}. For example, one of application and/or service APP 525₁-525_{S} is a directory service and the network communication includes a query against the name service with a domain name and/or host name. By way of further non-limiting example, one of application and/or service APP 525₁-525_{S} is an authentication server which provides a network service for authenticating credentials and the network communication includes an account name and password. By way of additional non-limiting example, one of application and/or service APP 525₁-525_{S} is a web application which is a client-server software application in which the client (or user interface) runs in a web browser (e.g., running on a Red Hat® JBoss® application server) and the network communication includes input to the web application.

At step 650, a response to the network communication is provided. In some embodiments, some output from the processing is sent to the originator of the network communication, such as attacker 450 (FIG. 5). For example, one of application and/or service APP 525₁-525_{S} is a directory service and the response includes a system-internal identification or addressing component, such as an IP address. By way of further non-limiting example, one of application and/or service APP 525₁-525_{S} is an authentication server and the response (e.g., when valid credentials are received) includes a (fake) cryptographic ticket for access to various services. By way of additional non-limiting example, one of application and/or service APP 525₁-525_{S} is a web application and the response includes output from the web application.

At step 660, behavior arising from the processing is logged and monitored. In some embodiments, monitoring logic monitors behaviors/changes (e.g., inbound and outbound network connections; process creation, changes, and removal; file and directory creation, change, and removal; memory usage change; disk usage change; network connection bonding of processes; and the like) caused/made by the application and/or service (e.g., one of APP 525₁-525_{S}) in response to the processing. In some embodiments, various combinations of steps 640-660 are performed concurrently and/or sequentially in any order.

Optionally at step 670, a log including the received (potentially) malicious communication, the response, and other logged activity can be provided. For example, the log can be provided to manager 560 (FIG. 5). By way of further non-limiting example, an alert of attack/intrusion may be provided to staff of an IT organization (e.g., associated with deception point 510), such as through manager 560. In some embodiments, behavior is (potentially) malicious when malware is detected in uploaded files; the monitored behavior is not in a whitelist; sensitive parts (e.g., name servers, time servers, authentication servers, database servers, file servers, and the like) of a network (e.g., data center 120 in FIG. 1) are accessed; and the like.

Optionally, steps 630-660 can be performed (e.g., concurrently and/or sequentially in any order) for a predetermined amount of time (e.g., specified in application image metadata as described below in relation to FIG. 7). When the predetermined amount of time has elapsed, deception point 510 (FIG. 5) can re-initialize the application/service (e.g., return one of application and/or service APP 525₁-525_{S} to a default state), such as by erasing storage used by the container (e.g., one of containers 520₁-520_{S}) and re-starting the container. In this way, the decoy can be ready for the next incoming connection (e.g., from attacker 450).

FIG. 7 depicts a simplified block diagram of system 700, in accordance with some embodiments. FIG. 7 illustrates additional and/or alternative elements of system 500 shown in FIG. 5. System 700 may include test bench 710, manager 760, production registry 770, and repository 570. In some embodiments, at least one of test bench 710, manager 760, production registry 770, and repository 570 are in one or more of data center 120 (FIG. 1). Manager 760 has at least some of the characteristics of manager 560 described above in relation to FIG. 5). For example, manager 760 gets an image associated with an application/service (APP) 725 from production registry 770 and communicates with container engine 730 to instantiate the application/service (APP) 725 in container 720. Repository 570 has at least some of the characteristics of repository 570 described above in relation to FIG. 5.

Test bench 710 can be combinations and permutations of a computing system as described below in relation to FIG. 9, a bare-metal server (e.g., physical hosts physical hosts 1601,1-160x,y in FIG. 1), and a virtual machine. In some embodiments, test bench 710 comprises host operating system 750, container engine 730, verification logic 740, containers 720, and application and/or service 725. Host operating system 750, container engine 730, container 720, application and/or service (APP) 725 can have at least some of the characteristics of host operating system 550 (and operating systems as described below in relation to FIG. 9), container engine 530, containers 520₁-520_{S}, and applications (APP) 525₁-525_{S}, respectively, as described above in relation to FIG. 5.

Verification logic 740 can be an application which checks compatibility between application and/or service (APP) 725 and deception point 510 (FIG. 5). In some embodiments, verification logic 740 is logically interposed between host operating system 750 and application and/or service (APP) 725. Verification logic 740 can perform a check and/or test of application and/or service (APP) 725 for compatibility (e.g., proper operation) in deception point 510. For example, verification logic 740 analyzes characteristics of an image (e.g., retrieved from production registry 770) associated with application and/or service (APP) 725 to ensure compatibility.

By way of further non-limiting example, verification logic 740 applies monitoring logic 540 to application and/or service (APP) 725 and checks that one or more hooks of monitoring logic 540 (described above in relation to FIG. 5) operate properly with application and/or service (APP) 725. Once verification logic determines application and/or service (APP) 725 is compatible with deception point 510, the image associated with application and/or service (APP) 725 can be stored in repository 570. The image can be stored with associated metadata, such as an application name, listening ports, and time for deception after an incoming connection. For example, the application name is a name of application/service associated with the image, the listening ports are one or more ports the application/service listens on, and the time for deception after an incoming connection is a predetermined amount of time the application and/or service instantiated in a container (e.g., the application/service (APP) 525₁-525_{S} in FIG. 5) imitates an actual application/service. In some embodiments, when the time for deception has elapsed, storage used by the container is cleaned up (e.g., erased) and the container re-started.

Production registry 770 can include images from a public registry and/or a private registry, where the images have been examined by staff of an information technology (IT) organization (e.g., associated with deception point 510) and approved for actual use (e.g., used in one or more of data centers 120 (FIG. 1) to provide an application and/or service. Registries and images were described above in relation to FIGS. 2, 3, and 5.

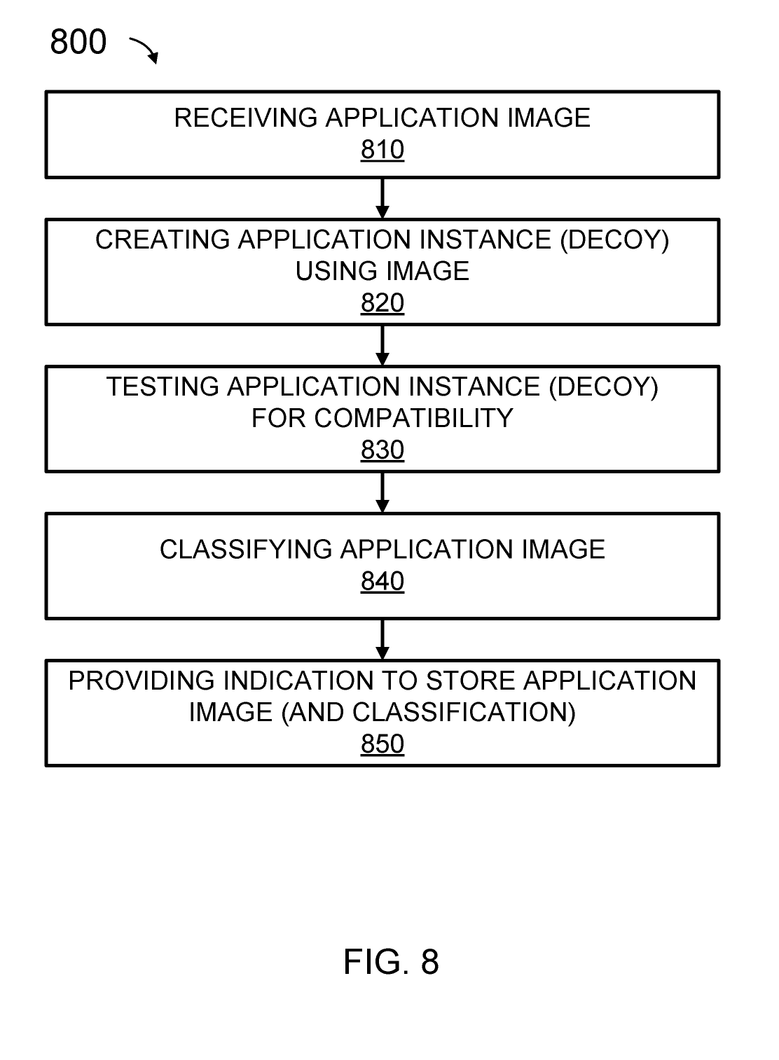

FIG. 8 is a simplified flow diagram for a method 800 for evaluating compatibility of an image with a deception point (e.g., deception point 510). In various embodiments, method 800 is performed by test bench 710 (FIG. 7). At step 810, an image for an application and/or service is received. In various embodiments, the image is received from manager 760, where manager 760 retrieves the image from production registry 770. For example, production registry 770 is where the IT organization stores application images for applications/services approved for actual use in the network (e.g., data center 120 in FIG. 1). Optionally, manager 760 can also store a local copy of the application image in memory or a data store of manager 760.

At step 820, a container with the application and/or service is instantiated. In some embodiments, container engine 730 (FIG. 7) creates container 720 for the application and/or service APP 725 using the image. For example, container 720 for the application and/or service APP 725 is to be tested for operation as a decoy.

At step 830, the container with the application and/or service is tested for compatibility with a deception point. In some embodiments, container 710 with application and/or service (APP) 725 is tested using verification logic 740 for compatibility with deception point 510 (FIG. 5). For example, characteristics of the image can be analyzed for compatibility with deception point 510. By way of further non-limiting example, one or more hooks can be applied to the application and/or service (APP) 725 in container 720 and success/failure determined for each hook.

At step 840, the image is classified and/or scored. In some embodiments, the image is classified as at least one of incompatible, partially compatible, and compatible, using the results of the testing. Alternatively, the image can be scored using a range of numbers (e.g., 1-10, 1-100, and the like) and/or letters (e.g., A, B, C, D, and F), where incompatible, partially compatible, and fully compatible correspond to a predetermined range of numbers and/or letters. For example, a score of 10, 100, and A are fully compatible; a score of 5-9, 50-99, and C-B are partially compatible; and a score of 1-4, 1-49, and F-D are incompatible. In various embodiments, a partial compatibility classification and/or score denotes for each monitoring feature which are compatible and/or incompatible with the image. Other ranges of numbers, letters, and predetermined ranges for classification can be used. The classification and/or score can be provided to manager 760 (FIG. 7).

At step 850, an indication to store the application image (and optionally the classification) are provided. In some embodiments, an indication to store the application image (e.g., the application image itself, a request, message, instruction, flag, tag, and the like) is provided to manager 760 (FIG. 7). Manager 760 can store the (partially compatible and/or fully compatible) image and optionally the classification in repository 570. For example, the application image can be provided to manager 760 (for storage in repository 570). Alternatively or additionally, manager 760 retrieves a copy of the application image from production registry 770 (for storage in repository 570). Alternatively or additionally, manager 760 can store a local copy of the application image in repository 570. In various embodiments, the image is stored with metadata indicating its compatibility classification and/or score. Additionally or alternatively, other metadata associated with the image, such as an application name, listening ports, and time for deception after an incoming connection, can be stored in repository 570 with the image.

FIG. 9 illustrates an exemplary computer system 900 that may be used to implement some embodiments of the present invention. The computer system 900 in FIG. 9 may be implemented in the contexts of the likes of computing systems, networks, servers, or combinations thereof. The computer system 900 in FIG. 9 includes one or more processor unit(s) 910 and main memory 920. Main memory 920 stores, in part, instructions and data for execution by processor unit(s) 910. Main memory 920 stores the executable code when in operation, in this example. The computer system 900 in FIG. 9 further includes a mass data storage 930, portable storage device 940, output devices 950, user input devices 960, a graphics display system 970, and peripheral device(s) 980.

The components shown in FIG. 9 are depicted as being connected via a single bus 990. The components may be connected through one or more data transport means. Processor unit(s) 910 and main memory 920 are connected via a local microprocessor bus, and the mass data storage 930, peripheral device(s) 980, portable storage device 940, and graphics display system 970 are connected via one or more input/output (I/O) buses.

Mass data storage 930, which can be implemented with a magnetic disk drive, solid state drive, or an optical disk drive, is a non-volatile storage device for storing data and instructions for use by processor unit(s) 910. Mass data storage 930 stores the system software for implementing embodiments of the present disclosure for purposes of loading that software into main memory 920.

Portable storage device 940 operates in conjunction with a portable non-volatile storage medium, such as a flash drive, floppy disk, compact disk, digital video disc, or Universal Serial Bus (USB) storage device, to input and output data and code to and from the computer system 900 in FIG. 9. The system software for implementing embodiments of the present disclosure is stored on such a portable medium and input to the computer system 900 via the portable storage device 940.

User input devices 960 can provide a portion of a user interface. User input devices 760 may include one or more microphones, an alphanumeric keypad, such as a keyboard, for inputting alphanumeric and other information, or a pointing device, such as a mouse, a trackball, stylus, or cursor direction keys. User input devices 960 can also include a touchscreen. Additionally, the computer system 900 as shown in FIG. 9 includes output devices 950. Suitable output devices 950 include speakers, printers, network interfaces, and monitors.

Graphics display system 970 include a liquid crystal display (LCD) or other suitable display device. Graphics display system 970 is configurable to receive textual and graphical information and processes the information for output to the display device.

Peripheral device(s) 980 may include any type of computer support device to add additional functionality to the computer system.

The components provided in the computer system 900 in FIG. 9 are those typically found in computer systems that may be suitable for use with embodiments of the present disclosure and are intended to represent a broad category of such computer components that are well known in the art. Thus, the computer system 900 in FIG. 9 can be a personal computer (PC), hand held computer system, telephone, mobile computer system, workstation, tablet, phablet, mobile phone, server, minicomputer, mainframe computer, wearable, or any other computer system. The computer may also include different bus configurations, networked platforms, multi-processor platforms, and the like. Various operating systems may be used including UNIX, LINUX, WINDOWS, MAC OS, PALM OS, QNX ANDROID, IOS, CHROME, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the technology. Those skilled in the art are familiar with instructions, processor(s), and storage media.

In some embodiments, the computing system 900 may be implemented as a cloud-based computing environment, such as a virtual machine operating within a computing cloud. In other embodiments, the computing system 900 may itself include a cloud-based computing environment, where the functionalities of the computing system 900 are executed in a distributed fashion. Thus, the computing system 900, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the computing system 600, with each server (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical, magnetic, and solid-state disks, such as a fixed disk. Volatile media include dynamic memory, such as system random-access memory (RAM). Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a programmable read-only memory (PROM), an erasable programmable read-only memory (EPROM), an electrically erasable programmable read-only memory (EEPROM), a Flash memory, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as JAVA, SMALLTALK, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

Aspects of the present technology are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The description of the present technology has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

What is claimed is:

1. A computer-implemented method for imitating an application in a deception point comprising:
getting an image for the application;
creating an instance of the application in a container using the image;
receiving a network communication, the network communication including an instruction for the application;
processing the instruction using the instance;
responding to the network communication using the processing; and
monitoring behavior from the processing, the monitoring including intercepting library calls, function calls, messages, and events from the container.

2. The method of claim 1, wherein the creating the instance includes:
producing the container using the image;
allocating a filesystem of a host operating system to the container;
adding a read-write layer to the image; and
launching a process specified by the image.

3. The method of claim 2, wherein the creating the instance is performed using Docker.

4. The method of claim 1 further comprising:
when a predetermined amount of time associated with the image has elapsed:
clearing file storage used by the instance; and
resetting the instance.

5. The method of claim 1 further comprising:
receiving a whitelist of benign behaviors, the benign behaviors including at least one of a Domain Name System (DNS) query, file type, Uniform Resource Locator (URL), and hash of an executable file;
checking the whitelist for the monitored behavior; and
issuing an alert when the monitored behavior is not on the whitelist.

6. The method of claim 1, wherein the monitored behavior includes uploading an executable file and the method further comprises:
hashing the uploaded executable file to produce a hash;
retrieving a malware analysis of the uploaded executable file using the hash; and
issuing an alert when the malware analysis indicates the presence of malware.

7. The method of claim 1, further comprising:
logging the monitored behavior; and
providing the log to a manager.

8. The method of claim 1, wherein the monitored behavior includes at least one of inbound and outbound network connections.

9. The method of claim 1, wherein the monitored behavior includes at least one of changing, creating, and removing one or more of a process, file, and directory; memory usage change; and disk usage change.

10. The method of claim 1, wherein the monitored behavior includes network bonding of processes.

11. A system for imitating an application in a deception point comprising:
a hardware processor; and
a memory coupled to the hardware processor, the memory storing instructions executable by the hardware processor to perform a method comprising:
getting an image for the application;
creating an instance of the application in a container using the image;
receiving a network communication, the network communication including an instruction for the application;
processing the instruction using the instance;
responding to the network communication using the processing; and
monitoring behavior from the processing, the monitoring including intercepting library calls, function calls, messages, and events from the container.

12. The system of claim 11, wherein the creating the instance includes:
producing the container using the image;
allocating a filesystem of a host operating system to the container;
adding a read-write layer to the image; and
launching a process specified by the image.

13. The system of claim 12, wherein the creating the instance is performed using Docker.

14. The system of claim 1, wherein the method further comprises:
when a predetermined amount of time associated with the image has elapsed:
clearing file storage used by the instance; and
resetting the instance.

15. The system of claim 11, wherein the method further comprises:
receiving a whitelist of benign behaviors, the benign behaviors including at least one of a Domain Name System (DNS) query, file type, Uniform Resource Locator (URL), and hash of an executable file;
checking the whitelist for the monitored behavior; and
issuing an alert when the monitored behavior is not on the whitelist.

16. The system of claim 11, wherein the monitored behavior includes uploading an executable file and the method further comprises:
hashing the uploaded executable file to produce a hash;
retrieving a malware analysis of the uploaded executable file using the hash; and
issuing an alert when the malware analysis indicates the presence of malware.

17. The system of claim 11, wherein the method further comprises:
logging the monitored behavior; and
providing the log to a manager.

18. The system of claim 11, wherein the monitored behavior includes at least one of inbound and outbound network connections.

19. The system of claim 11, wherein the monitored behavior includes at least one of changing, creating, and removing one or more of a process, file, and directory; memory usage change; and disk usage change.

20. A system for imitating an application in a deception point comprising:
a processor;
a memory coupled to the processor, the memory storing instructions executable by the processor to perform a method comprising:
getting an image for the application;
receiving a network communication, the network communication including an instruction for the application; and
responding to the network communication using processing;
means for creating an instance of the application in a container using the image;
means for the processing the instruction using the instance; and
means for monitoring behavior from the processing, the monitoring including intercepting library calls, function calls, messages, and events from the container.
